(19) United States
(12) Patent Application Publication
(10) Pub. No.: US 2006/0213205 A1
(43) Pub. Date: Sep. 28, 2006

(54) Baby bottle warmer

(76) Inventor: Victor J. Reverendo, Marysville, OH (US)

Correspondence Address: Douglas L. Wathen;Gifford, Krass, Groh, Sprinkle,, Anderson & Citkowski, P.C., PO Box 7021, Troy, MI, 48007-7021, US

(21) Appl. No.: 11/388,075

(22) Filed: Mar. 23, 2006

Related U.S. Application Data
(60) Provisional application No. 60/664,339, filed on Mar. 23, 2005.

(51) Int. Cl. F25B 21/02; F27D 11/00

(52) U.S. Cl. 62/3.3; 219/432

(57) ABSTRACT

An apparatus for modifying the temperature of bottle contents comprises a housing having an interior volume, and a housing opening through which the bottle and a fluid can be introduced to the interior volume. The fluid may be hot water, and the apparatus used as a baby bottle warmer. An insert can be used to receive the bottle, the insert having a plurality of apertures through which the fluid contacts the bottle.

### REFERENCE TO RELATED APPLICATION

This application claims priority from U.S. Provisional Patent Application 60/664,339, filed Mar. 23, 2005, the entire contents of which are incorporated herein by reference.

### FIELD OF THE INVENTION

The present invention relates to heating of containers, in particular to the warming of baby bottles.

### BACKGROUND OF THE INVENTION

Liquid baby food, such as milk or formula, is generally stored inside a refrigerator. However, the stored baby food is then too cold to be immediately fed to a baby. The baby food is ideally warmed to approximately human body temperature before feeding starts.

In a conventional approach, a baby bottle, containing the baby food, is placed in an open container of hot water. However, agitation of the bottle to speed heating often results in hot water leaking out of the open container. Spilled water can be both a hygiene problem and slipping hazard. Hence, the bottle is generally placed in the hot water and left to warm up without agitation, resulting in a slower warming process.

Additionally, the baby food may have multiple components (such as milk, formula, water, vitamins, anti-gas drops, or medications) that need to be mixed together before feeding. The mixing is usually carried out first, followed by the warming. The resulting delay may cause great agitation to a hungry baby, and distress to a parent having to suffer the resulting loud complaints of the baby.

U.S. Pat. Nos. 3,402,763 to Peterson, 4,163,471 to Leder, and 4,597,435 to Fosco, Jr., describe bottle warmers using constantly flowing hot water. This requires that the warmer remains close to a supply of hot water, such as in a kitchen or bathroom. A parent may prefer to hold the baby while seated, reassuring him or her that food is indeed on the way, and then have the bottle to hand when it is warmed. Most parents would prefer not to sit in a bathroom or kitchen. Also, the apparent wastefulness of warming a bottle using flowing hot water may not appeal to parents.

U.S. Pat. No. 6,571,564 to Upadhye describes an electrical heater with a preprogrammed timer. This may be useful if the feeding time can be predicted. However, babies often have their own unpredictable feeding agenda, and there is always a risk of overheating the contents of a bottle using an electrical heater. Also, electrical heaters require cables that may cause clutter or a tripping hazard.

U.S. Pat. No. 6,427,863 to Nichols describes a device having an integral thermos-style hot water storage region, and a separate cup stored inverted and outside the hot water storage volume in which the bottle can be warmed. This device could be useful while traveling or when otherwise not having a convenient source of hot water. However, most feedings take place at home where a source of hot water is available.

Hence, there is a need for a baby bottle warmer allowing agitation of the baby bottle without spilling the hot fluid used for warming.

### BRIEF DESCRIPTION OF THE DRAWINGS

FIG. 1 shows an external view of a bottle warmer;

FIG. 2 shows a cross-sectional view of a bottle warmer;

FIG. 3 shows a bottle inside a bottle warmer;

FIG. 4 shows a short bottle within a bottle warmer;

FIG. 5 shows a view of an insert;

FIG. 6 shows a bottle located within the insert; and

FIG. 7 shows a shorter bottle supported by the insert.

### SUMMARY OF THE INVENTION

An apparatus for modifying the temperature of bottle contents within a bottle comprises a housing, an inner surface of the housing defining an interior volume. The housing has a housing opening through which a fluid can be introduced to the interior volume, and through which a bottle can be passed so that the bottle is at least in part in contact with the fluid. In some embodiments of the present invention, an insert receives the bottle, the insert having a plurality of apertures through which the fluid may contact the bottle. The insert is located within the interior volume and is sized to receive the bottle, the bottle being passed through the housing opening and received by the insert. A sealing mechanism, such as a cap, prevents escape of the fluid from the interior volume, allowing the apparatus to be agitated. The fluid may be hot water, the apparatus being a baby bottle warmer. However, some embodiments of the present invention may also be used to warm any bottle, the term bottle being used to refer to any container. Some embodiments of the present invention may be used for bottle cooling, using for example an ice slurry as the fluid.

Hence, a method of changing the temperature of bottle contents comprises providing a housing having an interior volume and having a housing opening in which a fluid is located. The fluid has a different temperature to the bottle contents. The bottle is located at least in part within the interior volume, so as to be in contact with the fluid. An insert within the interior volume can be used to receive the bottle, the insert having a plurality of apertures through which the fluid contacts the bottle. At least part of the bottle, and possibly the entire bottle, is passed through the housing opening, the bottle being received by the insert so that the bottle is in contact with the fluid through the plurality of apertures in the insert. The interior volume is sealed so as to prevent escape of the fluid, for example using a cap, allowing the housing to be agitated. Agitation of the fluid and bottle contacts speeds the temperature change, due to enhanced heat transfer between the bottle contents and the fluid.

### DETAILED DESCRIPTION OF THE INVENTION

An improved bottle warmer comprises a housing enclosing an interior volume, the housing having a housing opening through which the interior volume can be partially filled with a heating fluid. A bottle can be inserted into the interior volume through the housing opening, and the interior volume sealed to prevent escape of the heating fluid. Agitation of the bottle warmer circulates the fluid over the bottle surface, warming the contents of the bottle. The heating fluid can be hot water, or another other heating fluid may be used. Apparatus according to the present invention can also be used to cool the contents of a bottle.

The housing may have a collar, protruding upwards from the main body of the housing, having an interior surface that defines the housing opening. The bottle warmer may further comprise a cap that attaches to the housing by any convenient method. For example, the cap may screw on to a threaded exterior surface of a collar of the housing.

In one example of use, a fluid is poured into the interior volume of the housing through a housing opening, and then the bottle is pushed through the housing opening so that at least part of the bottle surface contacts the fluid. A sealing mechanism then seals around a portion of the bottle to prevent the fluid from escaping. For example, a cap may be secured to the housing, the cap sealing the interior volume. The bottle may be entirely enclosed within the interior volume of the housing. The bottle may protrude from the interior volume, and the cap may be curved so as to enclose any part of the bottle protruding from the housing opening. For example a feeding nipple may protrude from the housing, and this may be covered by a domed cap. In some embodiments, a part of the bottle may protrude through a sealing mechanism, the fluid contacting a portion of the bottle surface.

In another example, a fluid is introduced into the interior volume of the housing through the housing opening, and the bottle to be warmed is then pushed through a central aperture in a cap and into the hot water. The central aperture then seals around some part of the bottle to prevent hot water from escaping from the interior volume. The cap need not be removed to pour hot water into the interior volume of the housing. The cap may be chosen so as to match a particular size or brand of bottle. The cap may be attached to the housing before or after introduction of the fluid, as the fluid may be introduced through the central aperture in the cap.

In this specification, the term ‘bottle’ refers to any container (which may be a single component or an assembly of multiple components), such as a baby bottle, having bottle contents that may be warmed (or cooled) using examples of the present invention. The bottle may be provided by the user of the bottle warmer, or one or more bottles may be packaged with a bottle warmer according to the present invention as a kit. A bottle may include multiple components associated with baby feeding or other fluid dispensation process associated with the bottle. Hot water can be used as the fluid, so that the interior volume of the housing acts as a hot water chamber.

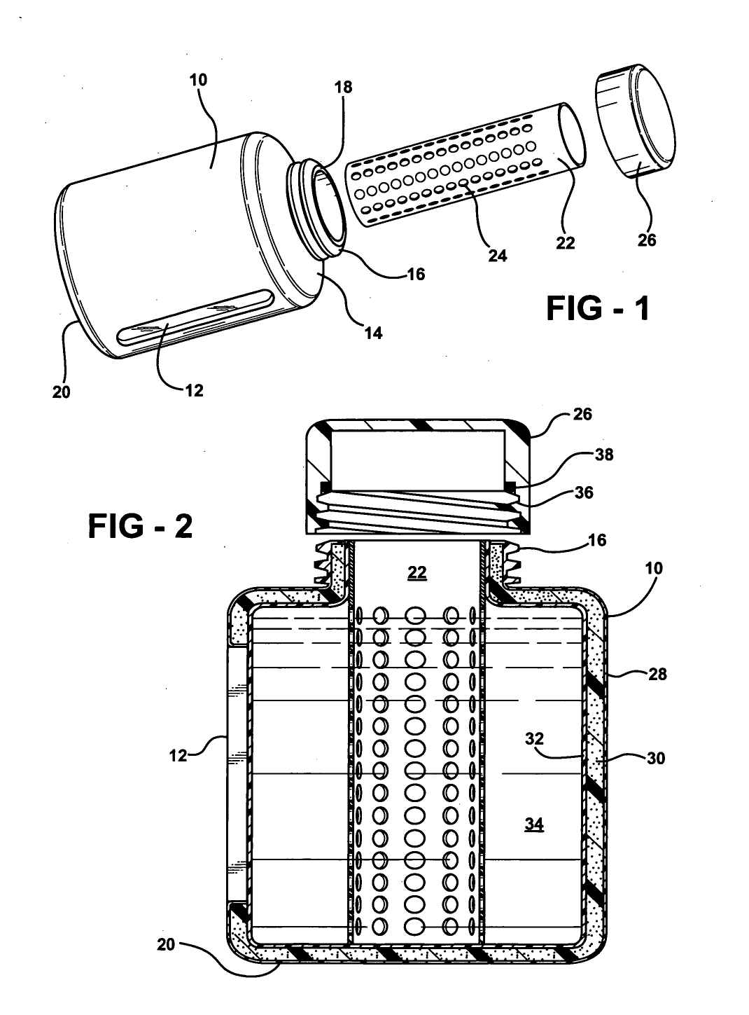

FIG. 1 shows a view of a bottle warmer according the present invention. The warmer comprises a housing 10, having a window 12 allowing a view of the fluid level, a top portion 14, a threaded collar 16 defining a housing opening 18, and a base 20. The figure also shows an insert 22, having a plurality of apertures 24, and a cap 26 that can be secured to the collar 16 using the threading of the outside surface of the collar 16. FIG. 2 shows a cross-sectional view, showing housing 10 comprising an outer shell 28, insulation layer 30, and inner shell 32. The removable insert 22, which may be a perforated plastic tube, is located centrally within the housing. Once located within the interior volume, the insert acts as a bottle holder, and fits inside the housing so that a bottle placed within the housing is held within the insert. The apertures 24 in the insert 22 allow a fluid within the interior volume 34 to contact the surface of a bottle received by the insert, more efficiently heating the bottle contents. The cap 26 seals the interior volume, and includes a sealing ring 38 that is compressed when the inside threading 36 of the cap is screwed down onto the threaded collar 16. The use of a threaded connection is optional. For example, a cap may attach to the housing by any appropriate mechanism, such as a snap connection, or using clips or another connector.

Different inserts can be provided, shaped to accept different bottle shapes. In some examples, the insert can be formed of an elastic or otherwise deformable material. An insert can be removed from the housing by turning the housing upside down, and allowing the insert to fall out, or by pulling on a part of the insert. A secondary insert may be inserted into a main insert to support a shorter bottle, so that the bottle can be removed without reaching down far into the housing.

In some examples, the outer shell of the housing wall may be omitted, the wall comprising a blow molded plastic inner shell (or liner), and a thermal insulation shell. The use of thermal insulation in the housing wall is optional.

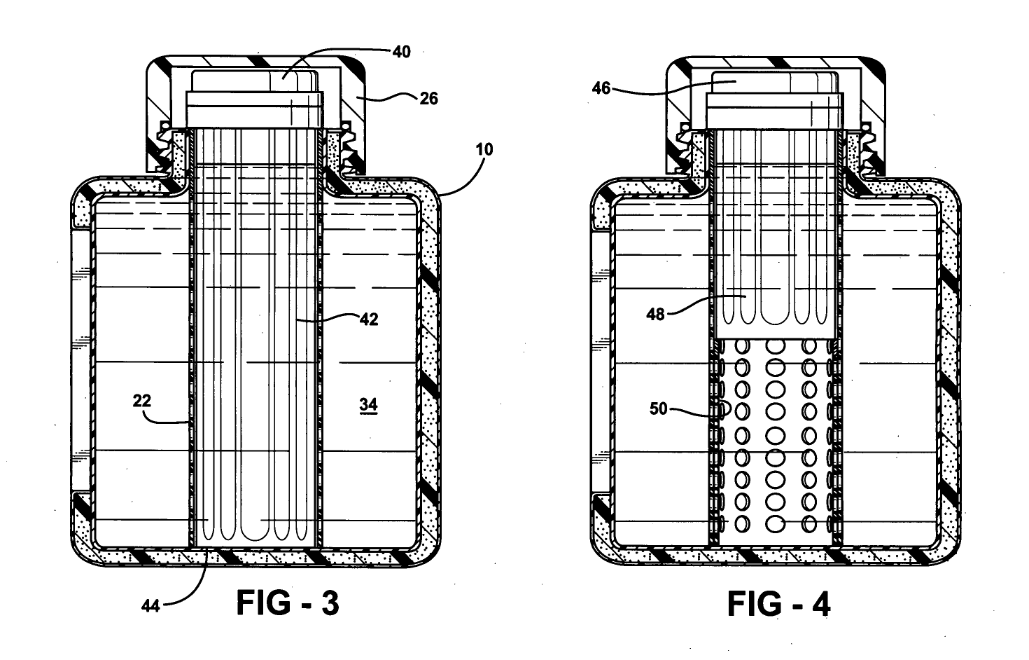

FIG. 3 shows a housing 10 containing a fluid, and a bottle 42 passed through the housing opening into the interior volume 34 of the housing. The bottle includes bottle cap 40. A cap 26 is secured over the housing opening of the housing, sealing the housing against fluid leakage. The housing can then be shaken, agitating the bottle contents and fluid within the interior volume, hence increasing the warming speed of the bottle contents. After the bottle is warmed, the cap can be removed, and the bottle removed from the housing.

FIG. 4 shows the housing 10, with a shorter bottle 48 (including cap 46) that does not extend to the base of the interior volume. The bottle 48 is passed through the housing opening into the interior volume. A stop, such as a protrusion, can be used to hold the bottle in position. The cap 46 may be sized so as to not pass through the housing opening, but, for example, to rest on the top of the collar.

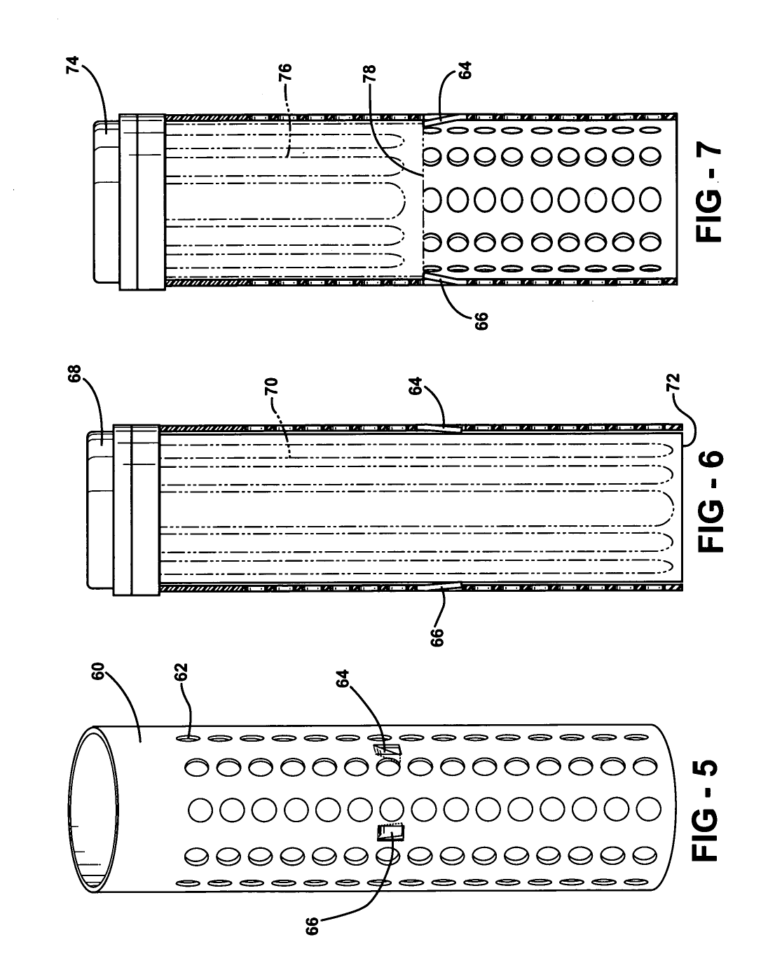

FIG. 5 illustrates an insert 60, having a plurality of apertures such as 62 through which fluid can pass. The insert also has tabs 64 and 66, which can be used to support shorter bottles. FIG. 6 shows a bottle 70 (including bottle cap 68), introduced to a first end of the insert, with a base 72 located at the second end of the insert. The tabs 64 and 66, hinged at the upper end (the end proximate to the insertion end) in this configuration, are pushed back as the bottle is inserted. FIG. 7 shows a shorter bottle introduced through the second end of the insert, supported by tabs that in this configuration are hinged at the bottom, away from the insertion end, and are not readily pushed out of the way. Hence, the insert receives a first bottle type in one orientation, and can be inverted to receive and support a second bottle type.

As an alternative, a spacer may be provided for supporting a shorter bottle. The spacer may take the form of a tube that is slightly smaller than the inside diameter of the insert. The spacer is preferably perforated to allow fluid circulation through it. The spacer is placed inside the insert and then a shorter bottle may be inserted in the insert and supported by the spacer. The spacer may be left in place or removed between uses. Other approaches for supporting a shorter bottle may also be used. Further, spacers for holding odd shaped or narrower bottles may be provided.

An example bottle warmer comprises a housing having an inner plastic liner and an outer Styrofoam insulation layer. The housing opening has a collar having an inside diameter of 3 inches, sized to accept most baby bottle sizes. A window, such as a slit or other opening in the insulation layer can be provided to allow the contents of the housing, such as the hot water level, to be observed through the plastic liner if this is translucent or transparent.

The housing of the bottle warmer encloses an interior volume, in which a fluid such as hot water can be introduced (for example, poured into through the housing opening), and in which the fluid contacts the walls of a bottle to heat (or cool) the contents of the bottle.

In examples of the present invention, a housing may have a circular base, a tubular side wall, a top portion which may taper upwards, and a collar protruding from the top portion. The collar may be omitted. The housing has a housing opening at or near the top of the housing when standing on the base.

In examples of the present invention, the housing of the bottle warmer is insulated, for example including an insulating layer. An insulating layer may comprise a foam layer, expanded polymer layer (such as Styrofoam), enclosed air, reflecting film (such as metalized plastic), or other insulating layer. A housing wall may comprise polymer sheets spaced apart by struts, and or otherwise provide an air-filled gap that acts as the insulating layer.

In other examples, the housing is not insulated, and may comprise a single layer of transparent or translucent plastic. An insulating layer can be provided as an accessory, if desired, for example in the form of a foam tube or foam cup-shaped object.

A housing opening allows a fluid such as hot water to be poured into the interior volume enclosed by the housing, and may also allow the bottle to pass at least in part into the interior volume, for example by passing slideably through the housing opening. For example, the housing opening may be surrounded by an externally threaded collar, to which a cap can be secured. The bottle can be passed through a central aperture within the cap, or the cap secured to the housing after the bottle has been passed through the housing opening.

The housing opening may be surrounded by a resilient material, which is the sealing component in a sealing mechanism. The sealing component may seal around a part of the bottle received by the bottle opening.

The housing can be provided with an optional second housing opening to facilitate drainage of the interior volume. For example, the second housing opening can be near a base of the housing.

Examples of the present invention may include a cap, which is securable to the housing. The cap may be secured using a push-on mechanism, a snap connect, by a threaded connection (for example, screwing the cap to a threaded collar), a magnetic securing mechanism, swinging arms, hook and loop attachments, suction, or other mechanism.

In another example of the present invention, the cap is first placed around the bottle, for example using a tightenable component, split-ring design, deformable element, or other mechanism such as discussed in relation to sealing mechanisms, or by pushing the bottle through a central aperture in the cap. The bottle and cap then form a combined assembly, so that securing the cap to the housing places the bottle in contact with the hot water.

The use of a cap is optional, as the interior volume can be sealed by contact between a bottle and the interior of the housing opening, or between a bottle and an insert.

The housing can be sealed against significant loss of any fluid from the interior volume after the bottle to be heated is placed in contact with the hot water in the interior volume. Example sealing mechanisms may include a gasket, split-ring, elastic washer, O-ring, rubber washer, grommet, other deformable or reconfigurable element, and the like.

The sealing mechanism may comprise a hydrophobic sheet having a hole. The sheet may be elastic in one or more directions. The sheet may be a plastic film, cloth material, rubber sheet, or the like.

A sealing mechanism may include a rubber sheet or washer having a central hole, optionally with radial cuts which distort in the direction of a bottle being pushed through the sealing mechanism.

A sealing mechanism may comprise one or more deformable elements, such which may comprise natural rubber, synthetic rubber such as silicone rubber, other polymer materials, and the like. The deformable element may comprise a thermoplastic, and deform more readily when heated by the proximity of a heating fluid.

The sealing mechanism may further (or alternatively) comprise a clip, threaded connection, push to fit connection, snap connection, contact adhesive, hook-and-loop connection, or a cable (such as wire, elastic band, and the like) that may hook over a cap or bottle.

The sealing mechanism may be located around the periphery of a housing opening, and sealing mechanism may be provided by a cap. For example, the cap may provide a central aperture through which the bottle can be pushed, the sealing mechanism forming a seal around some portion of the bottle. Alternatively, the cap may be secured over the bottle to seal the interior volume.

In other examples, the cap may be omitted, or not have a central aperture. In this case, the sealing mechanism can be provided by the housing opening.

The cap may be in the form of a ring having a central aperture similar in size to the housing opening, the cap being used to secure a sealing mechanism in place. For example, a circular rubber sheet with a central hole may be placed above the housing opening, and locked in place by tightening a cap over the central rubber sheet. The central rubber sheet may have radial cuts to increase the diameter of bottles which may pass through it.

A bottle warmer can be supplied with one or more removable inserts, the inserts being sized to accept different bottle sizes and/or shapes, and to hold them in place.

The insert may comprise a perforated plastic tube, mesh, netting material, elastic sheet, fabric, or other material. The insert has circulation holes, or is otherwise porous, to allow water, and therefore heat, to be exchanged across the insert (that is, between a region interior to the insert and a region exterior to the insert but interior to the housing of the bottle warmer).

The use of an insert is optional, but an insert can be configured to hold a bottle so that it can be easily removed from the interior volume, for example by holding the base of the bottle above the base of the housing of the bottle warmer, while allowing free fluid flow over the surface of the bottle.

An insert need not be removable, and may be permanently attached to the housing. However, the use of removable inserts allows different size bottle holders to be easily provided. The insert may be flexible, elastic, or otherwise expandable, for example using a concertina-style side wall, or adjustable depth within the interior volume. A flexible insert may help accommodate various bottle sizes, as well as bottles with some curvature along their length. A shaped insert may also be provided for specific bottle shapes, such as curved or oval.

The insert may also be fabricated from a material of high thermal conductivity, such as metal, for example, stainless steel. In other examples, the insert need not be porous, and seals a first volume of heating fluid in a region defined in part by the outer surface of the insert and the inner surface of the housing. A second volume of heating fluid is placed in the insert, and the bottle placed into the second volume of heating fluid. In this case, the insert may be a formed from a metal tube.

The insert may act so as to reduce the effective opening diameter of the housing opening. For example, the housing opening may have a diameter greater than most bottles, the insert effectively reducing the diameter to match with a particular bottle size or range of sizes.

The insert may comprise a resilient material, at least proximate to the housing opening, so that a bottle can be pushed through the resilient material so as to make a seal. The insert may comprise a flexible material so as to accommodate multiple bottle diameters.

Baby bottles, used to hold liquid food for a baby, typically are available in many shapes and sizes. The housing of a bottle warmer can be sized to accept any desired range of sizes or shapes. The baby warmer may be provided with different housing sizes (or different housing opening sizes), sizes corresponding approximately to baby age ranges, with larger sizes accepting larger bottles.

A baby bottle typically comprises a main bottle portion (which contains the food when the bottle is upright), a feeding nipple (typically rubber, for example silicone rubber), and a sealing ring. The sealing ring screws onto the main bottle portion, and holds the nipple in place.

A bottle warmer may be supplied with a number of inserts, having a variety of sizes to accept a variety of bottles, or an insert may be flexible so as to accept a range of bottle sizes. A user chooses an insert sized appropriately for the bottle used.

A bottle warmer may be supplied with a number of caps, each cap having a different sized central aperture. A user chooses a cap having an appropriate central aperture for the bottle used.

In other examples, the bottle warmer is designed to be used with a particular type of bottle, for example one having a specified circular cross-sectional diameter that matches the interior of a housing opening or central aperture of a cap. The bottle may also have a non-circular, or polygonal cross section, matching a corresponding interior cross-section of a housing opening or central aperture of a cap.

Even though the main bottle portions are available in many different sizes, typically the interior threading of the sealing ring and the exterior threading of the main bottle portion are a standard size. Hence, in examples of the present invention, sealing rings for baby bottles can be provided along with the bottle warmer, the sealing rings having a standard interior thread matching most makes of baby bottle, and a defined exterior size. For example, the sealing rings can have a circular profile at maximum cross-section, and optionally may have recessed bevels or other flat surfaces to assist turning of the sealing rings. The circular profile can be sized to match the interior size of the central aperture of a cap, for example the O-ring discussed above in relation to FIG. 1, or a housing opening through which the bottle is inserted. The nipple may protrude from the housing opening of the bottle warmer, allowing the temperature of the contents of the baby bottle to be periodically tested. The exterior diameter of the sealing ring may be greater than any part of the bottle, or the sealing ring may have radially extending flanges, so that the bottle can be supported by the ring resting on the housing opening. The ring may be transparent or translucent, to that it does not block the view of the baby when in use. The sealing ring may have an external thread that matches an internal thread of the housing aperture.

Examples above describe applications to bottle warming, in particular to baby bottle warming. Examples of the present invention can also be used for heating or cooling of any container. Containers which may be heated or cooled by examples of the present invention may contain: a carbonated or non-carbonated beverage, soup (or other consumable), bait, skin lotion or other cosmetic or medical product applied to the skin, or other item it may be advantageous to heat or cool.

In examples discussed above, hot water was used as a heating fluid. Similarly, iced water can be used as a cooling fluid. Other heating/cooling fluids can be used, such as oil (petrochemical or plant-derived), liquid nitrogen or other liquefied gas, aqueous solutions, sols, gels, solutions, emulsions, and the like.

In other examples, the container can be microwaveable, allowing the heating fluid to be heated using in a microwave oven. The heating fluid can be heated after the fluid is placed in the interior volume.

Patents, patent applications, or publications mentioned in this specification are incorporated herein by reference to the same extent as if each individual document was specifically and individually indicated to be incorporated by reference. In particular, U.S. Provisional Patent Application 60/664,339 is incorporated herein in its entirety.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

Having described our invention, we claim:

1. An apparatus for modifying the temperature of bottle contents within a bottle using a fluid, the apparatus comprising:
a housing, the housing enclosing an interior volume which receives the fluid, the housing having a housing opening;
an insert, located within the interior volume and sized to receive the bottle, the bottle being passed through the housing opening into the interior volume, the insert having a plurality of apertures therein so as to allow fluid within the interior volume to contact the bottle; and
a sealing mechanism, the sealing mechanism preventing escape of the fluid from the interior volume when the bottle is received by the insert.

2. The apparatus of claim 1, wherein the insert is substantially tubular.

3. The apparatus of claim 1, wherein the sealing mechanism is a cap, the cap being securable to the housing.

4. The apparatus of claim 3, wherein the housing has a collar, the inside surface of the collar defining the housing opening,
the cap being secured to the collar to prevent escape of the fluid from the interior volume.

5. The apparatus of claim 1, wherein the sealing mechanism comprises a sealing component surrounding the housing opening.

6. The apparatus of claim 5, wherein the sealing component is deformable or resilient.

7. The apparatus of claim 5, wherein the sealing component is ring-shaped.

8. The apparatus of claim 1, wherein the housing opening slideably receives the bottle.

9. The apparatus of claim 1, further comprising a cap, wherein the cap has a central aperture which slideably receives the bottle.

10. An apparatus for modifying the temperature of bottle contents within a bottle using a hot fluid, the apparatus comprising:
a housing, the housing enclosing an interior volume which receives the fluid, the housing having a housing opening; and
a sealing mechanism, the sealing mechanism preventing escape of the fluid from the interior volume when the bottle is received by the housing opening,
wherein the hot fluid is introduced into the interior volume, the housing opening slideably receiving the bottle so that the bottle is in contact with the hot fluid, the housing then being shakeable to promote heat transfer from the hot fluid to the bottle without fluid loss from the interior volume.

11. The apparatus of claim 10, wherein the sealing mechanism is a cap.

12. The apparatus of claim 11, wherein the cap is domed so as to enclose the bottle when the bottle is received by the housing opening.

13. A method of changing the temperature of bottle contents within a bottle using a fluid, the fluid having a different temperature to the bottle contents, the method comprising:
providing a housing having an interior volume, the housing having a housing opening, the interior volume containing the fluid;
providing an insert within the interior volume, the insert having a plurality of apertures;
passing at least part of the bottle through the housing opening, the bottle being received by the insert so that the bottle is in contact with the fluid through the plurality of apertures in the insert;
sealing the interior volume so as to prevent escape of the fluid; and
agitating the housing so to change the temperature of the bottle contents.

14. The method of claim 13, wherein the fluid is hot water, the method being a method of warming the bottle contents.

15. The method of claim 13, wherein the insert is substantially tubular, the insert being sized so as to slideably receive the bottle.

16. The method of claim 13, wherein sealing the interior volume comprises attaching a cap to the housing.

17. The method of claim 13, wherein attaching a cap to the housing comprises screwing the cap onto a threaded collar of the housing, an inside surface threaded collar defining the housing opening.
